(19) United States
(12) Patent Application Publication
(10) Pub. No.: US 2014/0008005 A1
(43) Pub. Date: Jan. 9, 2014

(54) Envelope And Method For Retreading Tires

(71) Applicant: BRIDGESTONE AMERICAS TIRE OPERATIONS, LLC, Nashville, TN (US)

(72) Inventor: Hideo Hara, Copley, OH (US)

(21) Appl. No.: 13/924,574

(22) Filed: Jun. 23, 2013

Related U.S. Application Data
(60) Provisional application No. 61/669,239, filed on Jul. 9, 2012.

(51) Int. Cl. B29D 30/54

(52) U.S. Cl. CPC B29D 30/542
USPC 156/128.1; 156/381

(57) ABSTRACT

A method of retreading a tire includes positioning a cured rubber tread around an outer circumferential surface of a tire casing to form a green retreaded tire assembly, the tread having a plurality of radially outwardly extending lugs; and placing the green retreaded tire assembly within an envelope having a plurality of radially outwardly extending recesses, each recess receiving a lug.

This application claims the benefit of U.S. Provisional Application Ser. No. 61/669,239, filed Jul. 9, 2012, which is incorporated herein by reference.

### FIELD OF THE INVENTION

One or more embodiments of the present invention relate to a system and method for retreading tires. In certain embodiments, the system and method of the present invention is particularly suited for retreading agricultural tires or other tires having aggressive tread patterns with relatively large lugs.

### BACKGROUND OF THE INVENTION

Methods of retreading tires are used to extend the life of tires, particularly trucks and off-road vehicles such as agricultural vehicles. By applying a new tread to a used tire casing, the life of the tire casing is extended. Retreaded tires often meet the same stringent quality standards as new tires and offer an economical and environmentally friendly alternative to new tires.

The retreading process includes first prepping the tire, which may involve the steps of inspecting, repairing and buffing the tire to remove any remaining tread to thereby create a desired circumference on the tire casing. Once the tire casing has been prepared, the retreaded tire is built; i.e., a new tire tread is secured to the outer circumferential surface of the casing. There are two basic methods of securing a new tread to a tire casing: the hot cure method (also referred to as mold cure) and the cold cure method (also referred to as pre cure).

In the hot cure process, a green or uncured tread rubber is positioned around the outer circumferential surface of the casing of the prepared tire and the tire and green tread are then cured in a curing mold to permanently adhere the new tread to the tire casing. In the cold cure process, an uncured cushion rubber is applied over the prepared outer circumferential surface of the tire to act as a binding agent between the tire and the new tread, which has already been cured. The tire, including the new cured tread and cushion rubber, is then cured in a heating chamber or autoclave to permanently adhere the new tread to the tire casing.

An envelope may be positioned around the tire during the curing process of the cold cure retreading method. The envelope is a flexible rubber case that fits over the tire and may be secured at axially spaced radially inward ends to a rim. The envelope provides a hermetic seal around the tire and may be connected to a vacuum that depressurizes the interior of the envelope during at least a portion of the curing process, which applies compressive forces to the tread. In certain circumstances, particularly where the tread includes large lugs extending radially outwardly from the tire, the forces applied by the envelope and the pressure within the curing environment can cause deformation of the tread. This deformation may result in an unusable retreaded tire or in a sub-optimal bond between the new tread rubber and the base tire. In addition, air left within the envelope during curing can negatively affect the bond created between the new tread and the tire casing.

Thus, there is a need for a system and method for retreading tires that alleviates one or more of the deficiencies of the prior art.

### SUMMARY OF THE INVENTION

One or more embodiments of the present invention provide a method for retreading a tire including positioning a cured rubber tread around an outer circumferential surface of a tire casing to form a green retreaded tire assembly, the tread having a plurality of radially outwardly extending lugs; and placing the green retreaded tire assembly within an envelope having a plurality of radially outwardly extending recesses, each recess receiving a lug.

One or more embodiments of the present invention also provides a method of retreading a tire including positioning a layer of uncured cushion rubber around an outer circumferential surface of a tire casing; positioning a cured tread around outer circumferential surface of the tire casing over the uncured cushion rubber, the tread having a plurality of radially outwardly extending lugs to form a green retreaded tire assembly; placing the green retreaded tire assembly within an envelope having a plurality of radially outwardly extending recesses, each recess adapted to receive a lug therein; mounting the green retreaded tire assembly and envelope on a rim to form a tire assembly; depressurizing the envelope of the tire assembly; and positioning the tire assembly in a curing environment to cure the cushion rubber.

One or more embodiments of the present invention also provides an envelope for use in a retreading process including an outer circumferential surface; axially spaced radial edges positioned radially inwardly from the outer circumferential surface; axially spaced side walls extending between the radial edges and outer circumferential surface; and a plurality of recesses extending radially outwardly from the outer circumferential surface for receiving lugs of a green retreaded tire assembly.

### BRIEF DESCRIPTION OF THE DRAWINGS

FIG. 1 is a section view of a retreaded tire in a curing envelope according to the concepts of the present invention;

FIG. 2 is a perspective view of a retreaded agricultural tire having a tread pattern suited for application of the concepts of the present invention; and

FIG. 3 is a sectional view of a rubber envelope according to the concepts of the present invention.

### DETAILED DESCRIPTION OF THE ILLUSTRATIVE EMBODIMENTS

In one or more embodiments, the methods of retreading a tire according to the concepts of the present invention include positioning a retreaded tire assembly in an envelope during at least a portion of the curing process. In certain embodiments, the envelope may include recesses, which may also be referred to as pockets, projecting radially outwardly, the recesses being sized and shaped to receive the lugs of the new tread positioned around an old tire casing. As will be appreciated by those skilled in the art, the inclusion of the recesses in the envelope allows the envelope to conform to the shape of the tread, and reduces or eliminates deformation of the lugs when the chamber formed by the envelope is depressurized. In addition, less air remains within the envelope of the present invention following depressurization, as compared to conventional envelopes without recesses, resulting in an improved bond between the new tread and the tire casing. The envelope and methods of the present invention may be particularly suited for use in retreading off-road vehicle and agricultural equipment tires, which tend to have treads with relatively large lugs.

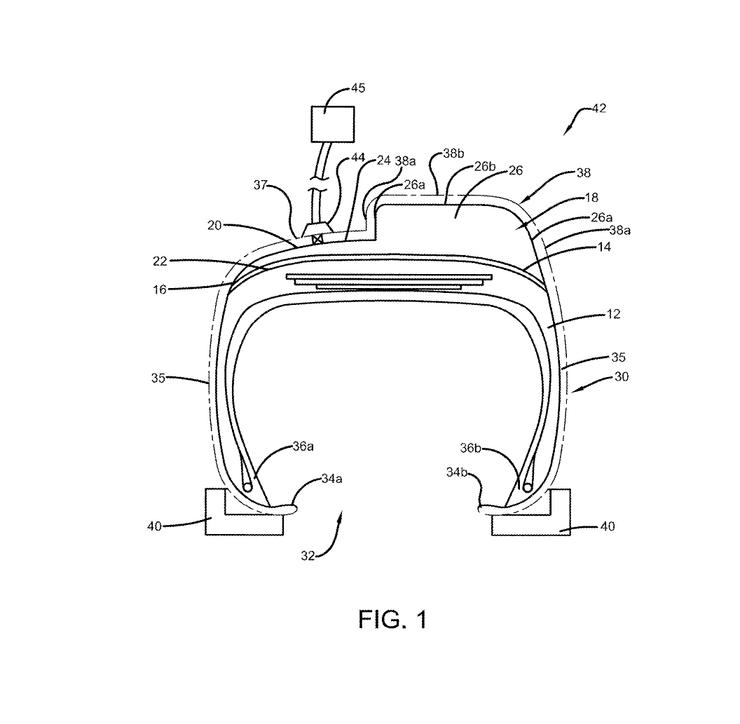

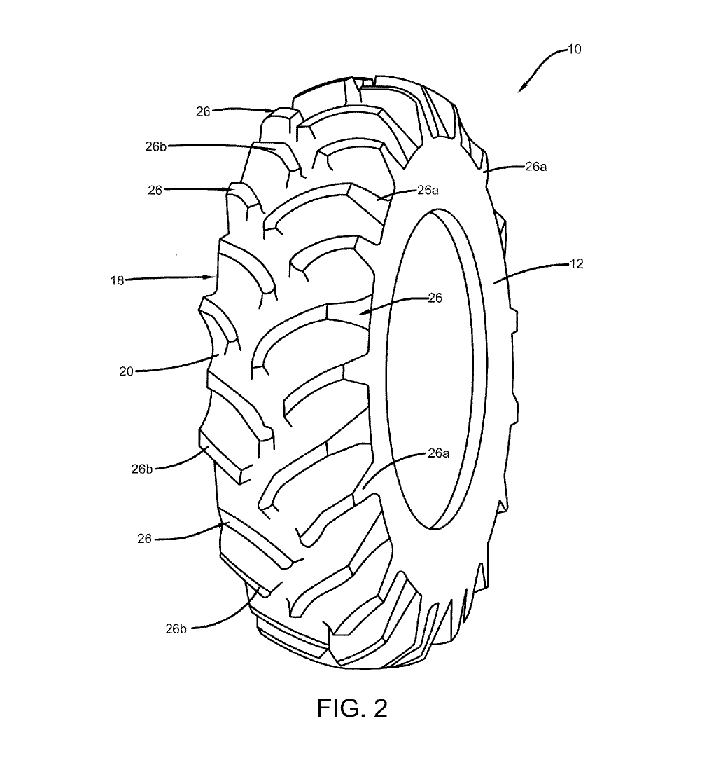

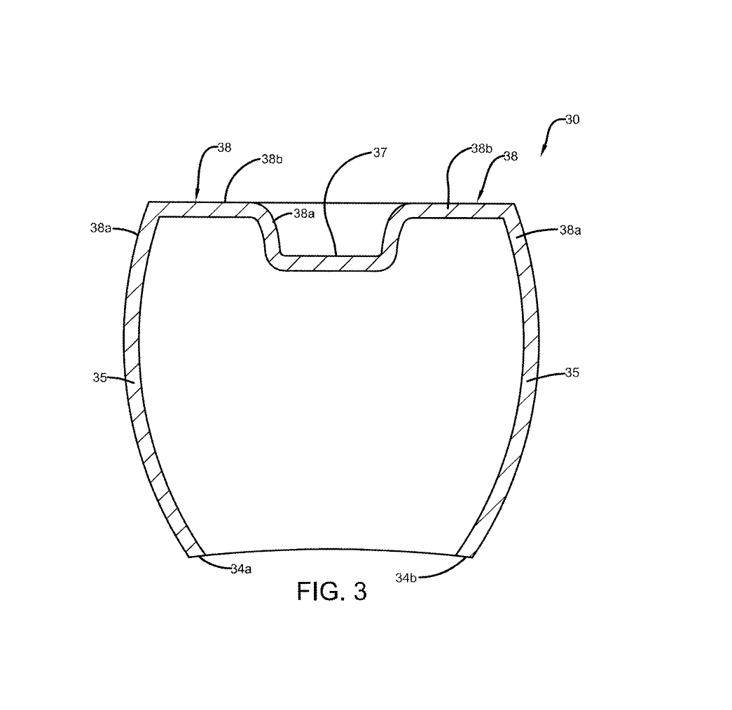

Referring to FIGS. 1-3, a method of forming a retreaded tire 10 according to the concepts of the present invention may include any known conventional steps to prepare a tire casing 12 to receive a new tread. In one or more embodiments, the tire casing 12 may first be inspected to ensure that it is a good candidate for retreading. In certain embodiments, the tire casing 12 may be manually inspected by a technician. In the same or other embodiments, the tire casing 12 may be inspected by non-destructive inspection equipment. For example, in certain embodiments, tire inspection may be performed using X-Ray equipment that detects foreign objects lodged in the tire casing and other defects that may impact the suitability of the tire for retreading.

In one or more embodiments, following the step of inspection, and assuming the tire carcass 12 is deemed suitable for further processing and retreading, the tire may be buffed. Buffing involves the mechanical removal of any remaining tread on the tire and creates a desired outer profile 14, which is the outer circumferential surface of the tire casing 12, for receiving a new tread. Buffing may be performed by grinding equipment that removes the remaining tread rubber from the casing 12 of the tire. In certain embodiments, the buffing equipment may be controlled by an electronic control system that may be programmed to create a desired circumference and casing profile 14. U.S. Patent Application Publication 2011/0214801 discloses suitable buffing equipment for use in the retreading method of the present invention, and is incorporated herein by reference.

In one or more embodiments, the method of retreading may include the step of repairing defects in the tire casing 12. The repair work may be performed either prior to or after the step of buffing. In certain embodiments, the step of repairing defects may include filling holes such as, for example, nail holes, with an uncured rubber. The step of repairing the tire casing 12 may also include cleaning and filling other defects in the tire casing with uncured rubber. As will be appreciated by those skilled in the art, the uncured rubber used to repair defects in the tire casing 12 is cured during the curing process to permanently fill in the defects, and thereby prolong the useful life of the tire casing.

In one or more embodiments, the outer profile 14 of the tire casing 12 may receive a coating of cement once the buffing and repairs have been completed. In certain embodiments, the cement may be applied by spraying or by rolling. The cement provides a tacky surface for application of a cushion rubber, and any known rubber cements may be utilized in the method of the present invention. In one or more embodiments, the cement may include rubber and vulcanizing agents dispersed in a solvent. In certain embodiments, the rubber cement may be allowed to dry following application so that the solvent can evaporate, leaving a thin film of tacky rubber on the outer circumferential surface of the tire carcass.

U.S. Pat. No. 4,808,657 discloses a suitable rubber cement for use in the retreading process of the present invention, and is incorporated herein by reference for that purpose. Rubber cements are available in a variety of forms and from a variety of commercial vendors, such as, for example: Fiber Bond Cement manufactured and sold by Patch Rubber Company, and ZEVOC® manufactured by APV Engineered Coatings (water-based cement). It is also contemplated that the process of the present invention may be performed without applying a cement.

Once the tire casing 12 has been prepped, a new tire tread 18 may be applied, which may be referred to as building the tire, to form a green retreaded tire assembly. In one or more embodiments, a layer of cushion rubber 16 is positioned between the outer circumferential surface 14 of the tire casing 12 and the tire tread 18. In certain embodiments, the cushion rubber 16 may be applied to an interior surface of the new tire tread 18 prior to positioning the tread on the tire casing 12. In other embodiments, the cushion rubber 16 may be applied directly to the outer circumferential surface 14 of the tire casing 12 prior to positioning of the new tire tread 18 on the casing. In one or more embodiments, the cushion rubber 16 may be a strip of uncured rubber for bonding the cured tire casing 12 and the cured tread rubber 18 together. An exemplary bonding system and method suitable for securing the new tire tread 18 to the tire casing 12 is disclosed in U.S. Pat. No. 5,462,617, which is incorporated herein by reference.

In one or more embodiments, the cushion rubber 16 may be formed from a rubber vulcanizate having a high percentage or amount of natural rubber or synthetic rubber, or blends thereof. Suitable types of synthetic rubbers include those made from conjugated dienes having generally from about 4 to about 12 carbon atoms and, preferably from about 4 to about 8 carbon atoms such as butadiene, isoprene, from conjugated dienes having from 4 to 12 carbon atoms with monomers of vinyl substituted aromatics having from 8 to 12 carbon atoms such as styrene, alpha-methylstyrene, and the like. Examples of suitable synthetic rubbers include polybutadiene, polyisoprene, and styrene-butadiene rubber. In certain embodiments, the rubber may be compounded with conventional amounts of various additives such as, for example, oil, fillers, processing aids, zinc oxide, stearic acid, sulfur, various accelerators, antioxidants and antiozonants. U.S. Pat. No. 5,503,940 discloses a suitable cushion rubber and is incorporated herein by reference for that purpose.

In one or more embodiments, the tire tread 18 may be formed from conventional tread rubber compositions, as are well known to those skilled in the art. In certain embodiments, the tire tread may include natural rubber, synthetic rubbers, or blends thereof. In one or more embodiments, the tire tread may include known additives such as, for example, oils, fillers, processing aids, zinc oxide, stearic acid, sulfur, various accelerators, antioxidants and antiozonants. In certain embodiments, fillers may include carbon black and/or silica.

In one or more embodiments, the tire tread 18 may be substantially cured at the time of positioning the tread around the tire casing 12. Those skilled in the art will appreciate that curing is a matter of degree, and that rubber articles that are not 100% cured may still be referred to as cured or vulcanized. In one or more embodiments, the tire tread may be at least 80% cured when it is positioned around the tire casing, in other embodiments at least 85% cured, in other embodiments at least 90% cured, and in still other embodiments at least 95% cured.

In one or more embodiments, the tire tread 18 includes a band 20 that is generally planar and has a contact surface 22 that engages the cushion rubber and an outer surface 24 facing radially outwardly. A plurality of lugs 26 extend radially outwardly from the outer surface 24 of the band 20 to create a tread pattern on the outer circumferential surface of the tire 10. In certain embodiments, each of the lugs 26 may include a plurality of side surfaces 26a extending away from the band 20 and tire casing 12, and an engagement surface 26b for contacting the ground.

Any number of lugs 26 in any desired sizes and shapes may be provided to produce innumerable tread patterns. In the case of off-road and agricultural vehicle tires, the lugs 26 may have a height, as compared to the height of the band 20, that is relatively large in order to provide the necessary traction and grip in off-road conditions. The height of the band 20 and the lugs 26 refers to the radial distance between the contact surface 22 and the most distal radial point or surface of the lug 26.

In one or more embodiments, the height of the lug 26 and the band 20 may have a ratio of at least 2.0:1, in other embodiments at least 2.5:1, in still other embodiments at least 3.0:1, and in yet other embodiments at least 3.5:1. In these or other embodiments, the lugs 26 may cover less than 60% of the outer surface 24 of the band, in other embodiments less than 55% of the outer surface of the band, and in yet other embodiments less than 50% of the outer surface of the band.

After positioning the tire tread 18 around the tire casing 12, the tread may be spliced at longitudinal ends of the band 20 to form a continuous outer surface of the tire. Known rubber splicing materials and techniques may be employed to splice the opposing longitudinal ends of the tread together. In certain embodiments, an adhesive may be applied to the longitudinal ends of the tread, and an uncured strip of splice rubber may be positioned between the longitudinal ends of the tread. As will be apparent to those skilled in the art, subsequent curing of the retreaded tire will create a continuous tire tread and permanently secure the longitudinal ends of the tread together.

In one or more embodiments, a green retreaded tire assembly, including the tire casing 12, cushion rubber 16, and tread 18, may be positioned within a rubber envelope 30 prior to curing. The adhesion between the tire casing 12 and the tread 18 has not been completed in the green retreaded tire assembly. In certain embodiments, the cushion rubber 16 of the green retreaded tire assembly is substantially uncured.

The rubber envelope includes an open end 32 facing an axis of rotation of the envelope. The open end 32 is defined by opposing radial edges 34a and 34b, which are adapted to be positioned adjacent to the bead portions 36a and 36b of the tire casing 12. Sidewalls 35 of the envelope extend radially from the radial edges to an outer circumferential surface 37. Thus, as will be appreciated by those skilled in the art, the envelope 30 has the same general shape as the green retreaded tire assembly. The envelope 30 is sized to fit snugly over the tread 18 and to allow the radial edges 34a and 34b to extend beyond the bead portions 36a and 36b of the tire casing 12.

In one or more embodiments, the envelope 30 may be spread to allow insertion of the green retreaded tire assembly. Any conventional devices and methods may be employed to spread the envelope 30 and position the green retreaded tire assembly within the spread envelope. In certain embodiments, the envelope 30 may be spread by a machine having a plurality of arms extending radially from the envelope, the arms adapted to engage one of the radial edges 34a or 34b and stretch it radially outwardly to enlarge the diameter of the opening defined by the radial edge. Following insertion of the green retreaded tire assembly, the arms are adapted to release the radial edge to allow it to return to its original position.

In one or more embodiments, the envelope 30 includes a plurality of recesses 38 extending radially outwardly from the outer circumferential surface 37. In certain embodiments, the recesses 38 may each be sized and shaped to receive a lug therein. Accordingly, the dimensions of each of the recesses 38 are substantially similar to but slightly larger than the dimensions of the lugs 26 to be received therein. The number and spacing of the recesses 38 may conform to the number and spacing of the lugs 26 so that each recess 38 receives a single lug 26 therein. In certain embodiments, each recess 38 may include side surfaces 38a extending radially outwardly from the outer circumferential surface 37 and a distal surface 38b corresponding to the side surfaces 26a and engagement surfaces 26b of the lugs 26, respectively. As a result, the envelope 30 has substantially the same outer profile as the tread 18 prior to depressurization of the envelope, as discussed below.

In one or more embodiments, the green retreaded tire assembly and envelope 30 may be mounted on a rim 40 following insertion of the green retreaded tire assembly into the envelope. The envelope 30 is trapped between the green retreaded tire assembly and the rim 40 adjacent to the bead portions 36a and 36b and the radial edges 34a and 34b. The tire casing 12 may then be inflated, such as by an inflation tube (not shown), to create an increased pressure within the tire and exert a sealing pressure between the green retreaded tire assembly, the envelope 30 and the rim 40. As will be understood by those skilled in the art, the interior of the envelope 30 is sealed at the rim 49 by virtue of the internal pressure within tire casing 12 to create an inner space between the envelope 30 and the green retreaded tire assembly. When mounted on the rim 40, the green retreaded tire assembly and envelope 30 may be referred to as a tire assembly 42.

In one or more embodiments, the tire assembly 42 may be transported to a curing environment following mounting of the green retreaded tire assembly and envelope 30 on the rim 40. In certain embodiments, the curing environment may be, for example, an autoclave or pressure vessel in which the temperature and pressure are controlled. In one or more embodiments, a plurality of tire assemblies 42 may be placed in the curing environment together to allow for simultaneous curing of the assemblies. In certain embodiments, a heated and/or pressurized curing medium, such as, for example, air, water, steam, or a combination thereof, may be introduced into the curing environment to simultaneously press the tread 18 against the tire casing 12 and cure the cushion rubber 16 positioned therebetween. Upon exiting the curing environment, the green retreaded tire assembly is converted to a retreaded tire 10, with the cushion rubber 16 substantially cured and creating a permanent bond between the tire casing 12 and the tread 18.

In one or more embodiments, the curing medium within the curing environment (e.g. air or steam) may create a pressure within the curing environment of at least 5 kg/cm², in other embodiments a pressure of at least 5.5 kg/cm², in still other embodiments a pressure of at least 6.0 kg/cm², and in yet other embodiments a pressure of at least 7 kg/cm².

In one or more embodiments, the curing medium within the curing environment (e.g. air or steam) may create a temperature within the curing environment of at least 100° C., in other embodiments a temperature of at least 105° C., in still other embodiments a temperature of at least 110° C., and in yet other embodiments a temperature of at least 115° C.

In one or more embodiments, the tire assembly 42 may remain in the curing environment for at least 2.0 hours, in other embodiments at least 2.5 hours, in still other embodiments at least 3.0 hours, and in yet other embodiments at least 3.5 hours.

In one or more embodiments, the envelope 30 may include a valve 44 that allows fluid to flow from one side of the envelope 30 to the other. The valve 44 may be any known and conventional valve for suitable for transfer of gasses, and may be manufactured as an integral component of the envelope 30. The valve 44 communicates with the inner space between the envelope 30 and tire 10.

In one or more embodiments, the valve 44 may be connected to and in fluid communication with a vacuum source 45 to depressurize the envelope 30 and reduce or substantially eliminate air within the envelope 30 of the tire assembly 42. In one or more embodiments, the envelope may be depressurized throughout the curing process. In other embodiments, the envelope 30 may be depressurized for at least a portion of the curing process.

As will be apparent to those skilled in the art, the inclusion of recesses 38 in the envelope 30 allows for an intimate relationship between the envelope 30 and tread 18 across substantially all of the surface area of the lugs 26. This intimate relationship prevents deformation of the lugs 26 in the pressurized curing environment, and reduces the amount of air remaining within the envelope to improve the bond between the tread 18 and the tire casing 10 of the retreaded tire. U.S. Pat. No. 4,434,018 discloses suitable retread curing equipment and methods, and is incorporated herein by reference for that purpose.

Following curing, the tire assembly 42 may be removed from the curing environment, and the valve 44 may be opened to allow air to reenter the inner space of the envelope 30. In one or more embodiments, the retreaded tire 10, with the tread 18 permanently adhered thereto, and the envelope 30 may then be removed from the rim 40. In certain embodiments, the retreaded tire 10 may then be inspected to ensure that the tread 18 is properly secured to the tire casing 10. In one or more embodiments, excess tread rubber may be removed and the tire may be painted and readied for subsequent use.

In an alternative embodiment, the lugs 26 may be provided as separate and discrete components, rather than as projections from the band 20. In these embodiments, method of forming a retreaded tire may include positioning the lugs 26 within the recesses 38 before or after insertion of a tire casing 12, cushion rubber 16, and/or tread band 20 within the envelope 30. In certain embodiments, the recesses 38 may be sized and shaped so as to impart a compressive force on the lugs 26 upon insertion, thereby maintaining the lugs 26 within the recesses 38 following insertion. As discussed above, the recesses 38 are adapted to conform to the shape of the lugs 26.

In one or more embodiments, a tire casing 12 may be positioned within an envelope 30 having recesses 38 containing lugs 26 therein. In certain embodiments, the tire casing 12 may have a cushion rubber 16 disposed on an outer circumferential surface thereof when inserted into the envelope 30 to facilitate adhesion of the lugs 26 to the tire casing 12. It is also contemplated that in certain embodiments a tread band 20 having a generally planar sectional profile may be positioned over the cushion rubber 16, and a second layer of cushion rubber may be provided over the tread band 20. In one or more embodiments, a rubber cement and/or cushion rubber may be applied to a contact surface of the lugs 26 before or after insertion of the lugs 26 into the recesses 38 to facilitate bonding of the lugs to the tire casing 12, tread rubber 20, or cushion rubber 16.

Following insertion of the lugs 26 into the recesses 38 and positioning of a tire casing 12, cushion rubber 16, and optionally a tread band 20 and a second layer of cushion rubber within the envelope 30, the method of forming the retreaded tire proceeds as discussed above. A tire assembly 42 is formed with a rim 40, and the tire assembly is cured. The depressurization of the envelope causes the lugs 26 to contact the exposed outer circumferential surface of the prepared tire casing, and the cushion rubber therebetween acts to permanently bond the lugs 26 to the tire casing. The correspondingly shaped lugs 26 and recesses 38 allow for removal of substantially all of the air between the tire casing 12 and the envelope 30 upon depressurization of the envelope, and prevents any substantially deformation of the lugs 26 during the curing process.

Various modifications and alterations that do not depart from the scope and spirit of this invention will become apparent to those skilled in the art. This invention is not to be unduly limited to the illustrative embodiments set forth herein.

What is claimed is:

1. A method of retreading a tire comprising:
(a) positioning a cured rubber tread around an outer circumferential surface of a tire casing to form a green retreaded tire assembly, the tread having a plurality of radially outwardly extending lugs; and
(b) placing the green retreaded tire assembly within an envelope having a plurality of radially outwardly extending recesses, each recess receiving a lug.

2. The method of claim 1, where the step of placing the green retreaded tire assembly within an envelope includes stretching the envelope.

3. The method of any one of claim 1, further comprising the step of mounting the green retreaded tire assembly and envelope on a rim to form a tire assembly.

4. The method of any one of claim 1, further comprising the step of placing the tire assembly in a curing environment.

5. The method of any one of claim 4, where the curing environment is pressurized.

6. The method of any one of claim 1, further comprising the step of depressurizing the envelope of the tire assembly.

7. The method of any one of claim 1, further comprising the step of buffing the outer circumferential surface of the tire casing.

8. The method of any one of claim 1, further comprising the step of positioning a layer of cushioning rubber over the outer circumferential surface of the tire casing prior to positioning the tread around the tire casing.

9. A method of retreading a tire comprising:
(a) positioning a layer of uncured cushion rubber around an outer circumferential surface of a tire casing;
(b) positioning a cured tread around outer circumferential surface of the tire casing over the uncured cushion rubber, the tread having a plurality of radially outwardly extending lugs to form a green retreaded tire assembly;
(c) placing the green retreaded tire assembly within an envelope having a plurality of radially outwardly extending recesses, each recess adapted to receive a lug therein;
(d) mounting the green retreaded tire assembly and envelope on a rim to form a tire assembly;
(e) depressurizing the envelope of the tire assembly; and
(f) positioning the tire assembly in a curing environment to cure the cushion rubber.

10. The method of claim 9, where the step of placing the green retreaded tire assembly within an envelope includes stretching the envelope.

11. The method of any one of claim 9, where a curing medium is introduced into the curing environment, the curing medium selected from the group consisting of air, water, steam and a combination of air and steam.

12. The method of any one of claim 11, where the curing environment is maintained at a pressure of at least 5 kg/cm² during curing of the tire assembly.

13. The method of any one of claim 12, where the curing environment is maintained at a temperature of at least 105° C.

14. The method of any one of claim 13, where the tire assembly is positioned within the curing environment for at least 2.0 hours.

15. An envelope for use in a retreading process, the envelope comprising:
(a) an outer circumferential surface;
(b) axially spaced radial edges positioned radially inwardly from the outer circumferential surface;
(c) axially spaced side walls extending between the radial edges and outer circumferential surface; and
(d) a plurality of recesses extending radially outwardly from the outer circumferential surface for receiving lugs of a green retreaded tire assembly.

16. The envelope of claim 15, where the sidewalls, radial edges and outer circumferential surfaces include vulcanized rubber.
